(19) United States
(12) Patent Application Publication
(10) Pub. No.: US 2003/0219075 A1
(43) Pub. Date: Nov. 27, 2003

(54) Method and apparatus of signal compression using adaptive pulse code modulation with frame width adjustment means

(76) Inventors: Chin-Chuan Liang, Hsinchu (TW); Tsung-Hau Shih, Hsinchu (TW); Shao-Shi Chen, Hsinchu (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/374,474

(22) Filed: Feb. 24, 2003

(30) Foreign Application Priority Data
May 27, 2002 (TW) 091111168

(51) Int. Cl. H04B 1/66

(52) U.S. Cl. 375/241

(57) ABSTRACT

A method and apparatus of signal compression using adaptive pulse code modulation (ADPCM) with variable width frame is provided. The present invention enables a low distortion rate in the process of the ADPCM signal compression by installing a frame width modifier on the input of a code analyzer and corrector which repetitively receives compressed data and generates reference values to attain an optimal delta value for a given resolution condition that enables high compression ratio and data integrity in the data compression and decompression processes.

### BACKGROUND OF THE INVENTION

1. Field of the Invention

The present invention relates to a method and apparatus of signal compression using adaptive pulse code modulation (ADPCM) with frame width adjustment means, in particular to a signal compression method that enables considerable improvement from the distortion rate experienced with a conventional ADPCM.

2. Description of Related Arts

Digital data has to be compressed to reduce the amount of data for more efficient use of the transmission channels. One of the popular compression techniques is the adaptive pulse code modulation (ADPCM).

The block diagram of an ADPCM encoder in FIG. 1A shows its internal architecture, and FIG. 1B is a corresponding ADPCM decoder. The ADPCM encoder shown in FIG. 1A comprises a quantizer (50), a dequantizer (60), an adaptive delta tuner (70) and a predictor (80). The function of the predictor (80) is to estimate the size of the next data expressed as p(nT_{S}) which is then subtracted from the input signal x(nT_{S}) through the service of a subtractor (92), generating a variance e(nT_{S}) representing the difference between the input signal and the estimated value. In the ideal situation, the variance is rather insignificant. The variance e(nT_{S}) is then used by the quantizer (50) together with the variable portion of the delta value d(nT_{S}) (supplied by the adaptive delta tuner (70)), to generate a compressed signal e_{c}(NT_{S}) provided a certain resolution is required.

In the dequantizer (60) on the right hand side of the diagram, the adder (91) and the predictor (80) serve the same purposes as the counterparts in the ADPCM decoder shown in FIG. 1B. The quantizer (60) in the encoder is used to verify the accuracy of the transmitted data. When the dequantizer (60) receives a compressed signal e_{c}(nT_{S}), it reverses the quantize process using the same delta value d(nT_{S}) and the same resolution as in the above-mentioned operation to generate a signal e_{q}(nT_{S}). Thereafter, the signal e_{q}(nT_{S}) is added to the predicted value p(nT_{S}) by the adder (91) to create the signal x_{q}(nT_{S}) to be input to the predictor (80).

The processes of quantizing and reverse quantizing mentioned in the previous paragraphs are repeated until an optimal delta value is attained for a given resolution that can produce minimal quantizing errors.

FIGS. 2A, 2B respectively show the delta values generated by the adaptive delta tuner (70) having a frame width of 3 bits and 2 bits respectively in the compressed signal e_{c}(nT_{S}). From comparison of the diagrams, it can be clearly seen that the delta value for the compressed signal e_{c}(nT_{S}) having an adaptive delta tuner (70) of 2 bits frame width is only half of that from the adaptive delta tuner (70) having 3 bits frame width and this means the parametric control of compression result is subject to the width of the signal frame in the adaptive delta tuner (70). Since the precision of delta value d(nT_{S}) for 2 bits frame width is much less than that with 3 bits frame width, the delta value d(nT_{S}) inputting to the quantizer (50) and dequantizer (60) will definitely cause larger quantization errors.

From the foregoing illustrations, it can be understood that the quantization errors in data compression and decompression are directly associated with a limited signal frame width used. In view that a high rate of quantization errors is largely unacceptable in commercial practices, the present invention provides a new approach to fulfill the requirements for data compression.

### SUMMARY OF THE INVENTION

The main object of the present invention is to provide a method and apparatus of signal compression using adaptive pulse code modulation (ADPCM) with frame width adjustment means, adaptive to a suitable frame width for the compressed codes that is able to maintain high compression ratio and low distortion rate.

The second object of the present invention is to incorporate a frame width adjustment means in the code analyzer and corrector that enables signal compression using adaptive pulse code modulation (ADPCM) with a variable width frame, whereby the code analyzer and corrector receives a compressed codes e_{c}(nT_{S}) from the encoder, and uses a repetitive prediction process to generate an appropriate reference value e_{c}′(nT_{S}) for the code analyzer and corrector.

The method in accordance with the invention comprises the steps of

quantizing the input signals;

dequantizing to restore the original input signal format before quantizing;

predicting a process that receives the result of dequantizing process and generates an estimated value for the next data;

generating a variance after subtracting the estimated value from the input signal through repetitive quantizing and dequantizing processes; and

tuning the frame width to adapt to the reference output from the code analyzer and corrector and generate a delta value, which has to be repetitively fed back to the quantizing and dequantizing processes before an optimal delta value is obtained.

The features and structure of the present invention will be more clearly understood when taken in conjunction with the accompanying figures.

### BRIEF DESCRIPTION OF THE DRAWINGS

FIGS. 1A, 1B are block diagrams showing an encoder and decoder respectively for a conventional ADPCM;

FIGS. 2A, 2B respectively show the characteristic curves of delta function for a code analyzer and corrector having 3 bits and 2 bits frame width respectively;

FIGS. 3A, 3B are block diagrams showing the encoder and decoder of the invention for an ADPCM;

FIG. 4 is a structural diagram of the proposed code analyzer and corrector; and

FIG. 5 is an actual implementation of the code analyzer and corrector of the invention.

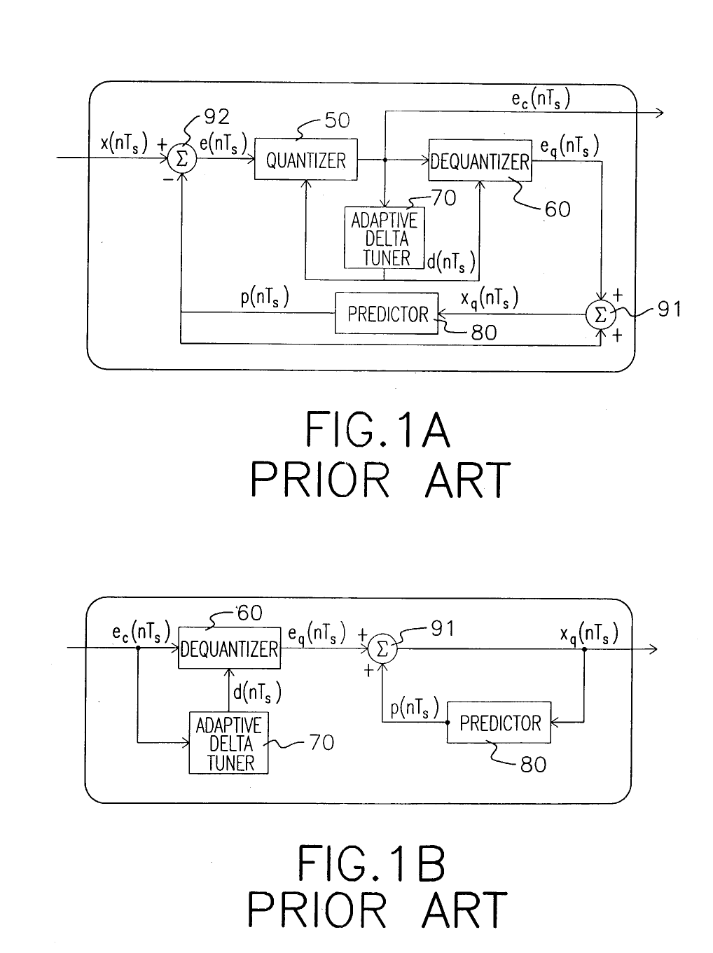

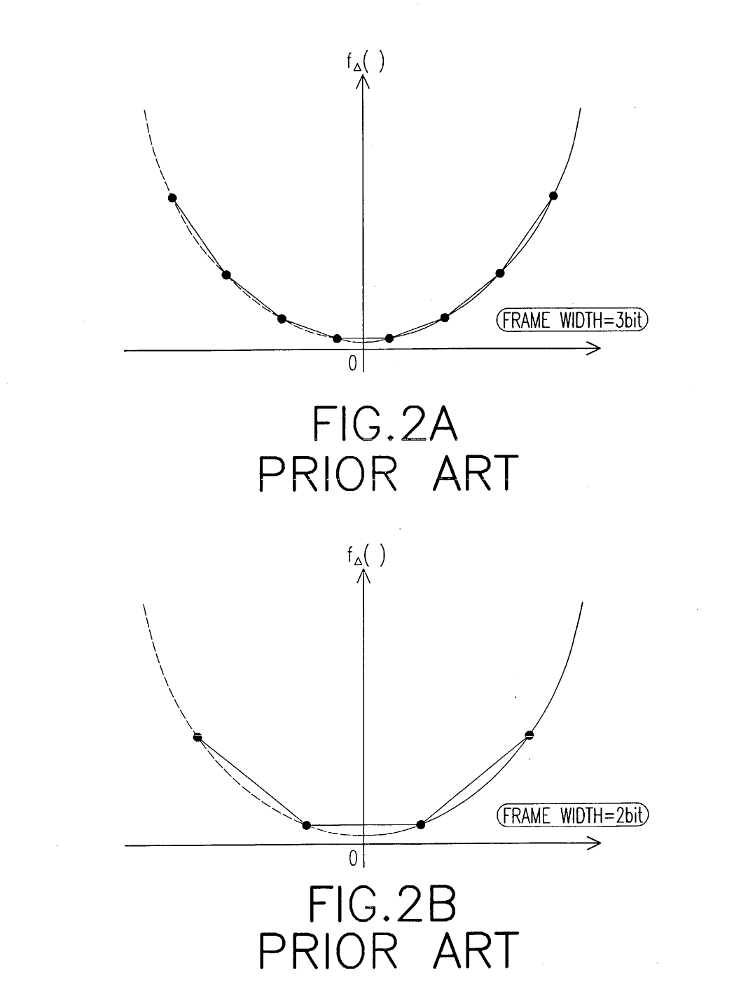

### DETAILED DESCRIPTION OF THE PREFERRED EMBODIMENT

In the following detailed description of the preferred embodiment, reference is made to the accompanying drawings, which shows specific embodiments in which the invention may be practiced. In the drawings, and like numerals describe substantially similar components throughout the several views. The embodiments are described in sufficient detail to enable those skilled in the art to practice the invention.

The present invention provides a method and apparatus of an adaptive pulse code modulation with frame width adjustment means, whereby the frame width can be tuned to adapt to the amount of input data to enable high compression ratio and low distortion rate.

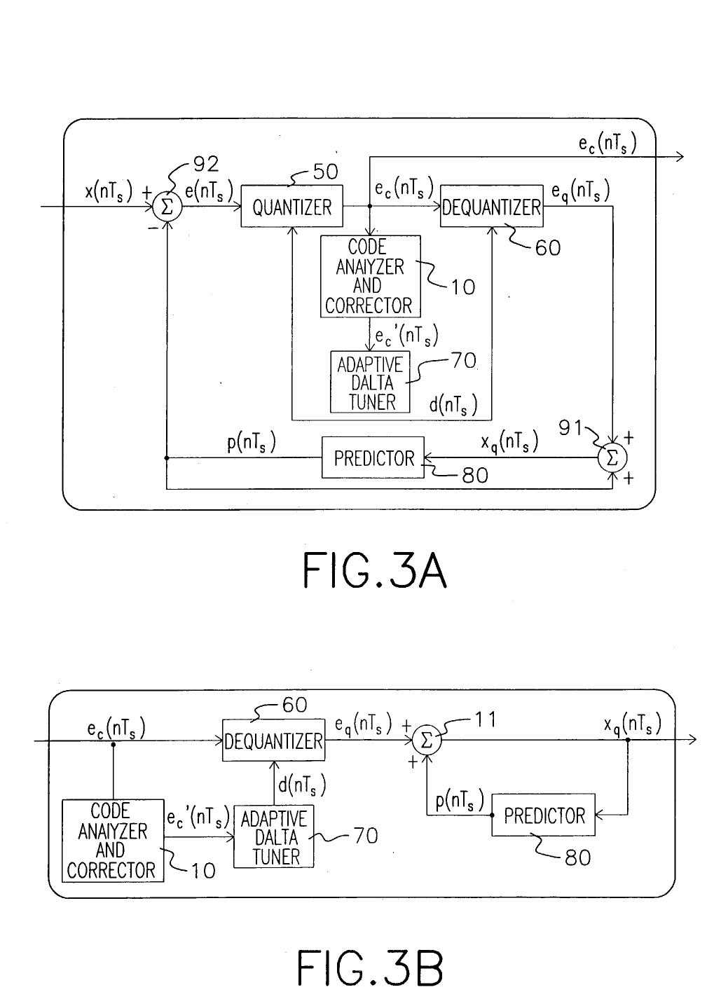

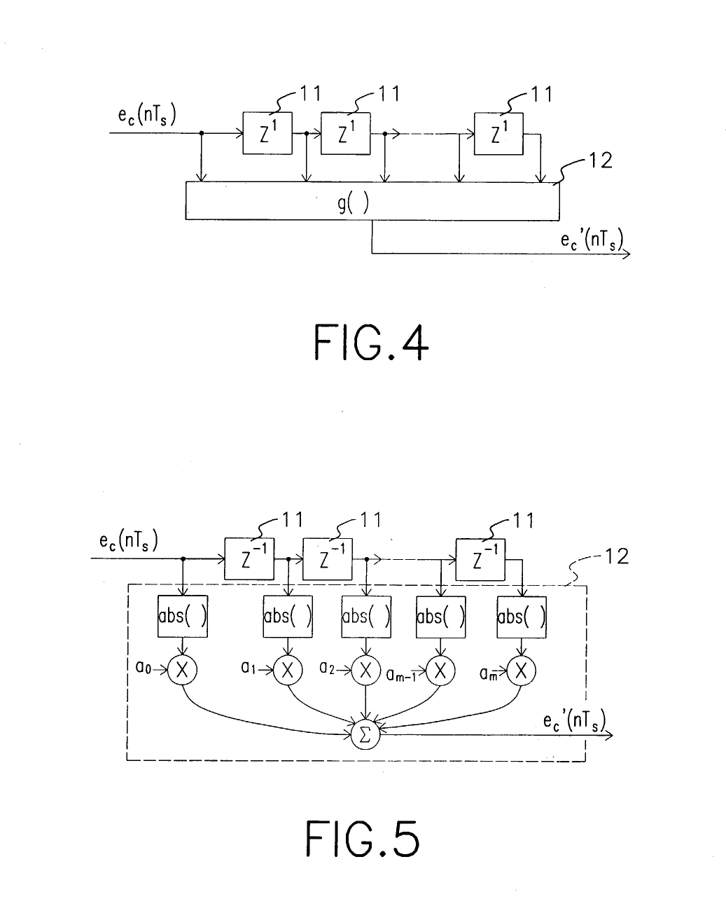

With reference to FIGS. 3A, 3B, the architecture of the encoder and decoder of the invention reveals a code analyzer and corrector (10) which is composed of a quantizer (50), a dequantizer (60), an adaptive delta tuner (70) and a predictor (80), wherein the code analyzer and corrector (10) receives compressed codes e_{c}(nT_{S}) from the quantizer (50) and passes them to the adaptive delta tuner (70) after frame width adjustment.

The code analyzer and corrector (10) further incorporates multiple delay elements (11) and a frame width modifier (12). The code analyzer and corrector (10) receives the compressed codes e_{c}(nT_{S}) supplied by the quantizer (50), and generates a reference value e_{c}′(nT_{S}) through multiple stages of delay elements (11), and then uses the compressed codes e_{c}(nT_{S}) from the frame width modifier (12) to generate a reference value e_{c}′(nT_{S}). The main function of the code analyzer and corrector (10) is to generate an output signal based on the compressed codes e_{c}(nT_{S}), before which the code analyzer and corrector (10) goes through a repetitive tuning process to allow the frame width to adapt to the characteristics of the compressed codes e_{c}(nT_{S}) for generating an appropriate reference value e_{c}′(nT_{S}).

As an example, the compressed code e_{c}(nT_{S}) generated by the quantizer (50) is derived from 2 bits frame width using the frame width modifier (12). It is then used by the adaptive delta tuner (70) based on 4 bits frame width to compute the reference value e_{c}′(nT_{S}). The results of the computation by the adaptive delta tuner reveal that the reference value computed with 4 bits frame width is more accurate than that with 2 bits frame width. It is clear that the frame width as an input parameter can greatly affect the accuracy of the resultant delta value, thus the quantizing errors can be significantly reduced.

FIG. 5 shows the architecture of the frame width modifier (12) in one embodiment of the invention, which treats the preceding compressed code as an absolute value, then each is multiplied by a modifier (a0, a1, . . . , am), and the resultant values are summed to yield a reference value e_{c}′(nT_{S}). In accordance with the present invention, for code compression with a smaller frame width, the frame width modifier (12) in the code analyzer and corrector (10) can be applied to supplement the quantity of bits in the signal frame to enable more precise computation of the delta value in the quantizing and dequantizing processes, whilst still maintaining a high compression ratio and a low distortion rate in the data compression.

The foregoing description of the preferred embodiments of the present invention is intended to be illustrative only and, under no circumstances, should the scope of the present invention be so restricted.

What is claimed is:

1. A method of adaptive pulse code modulation with frame width adjustment means, comprising the steps of:
quantizing input signals;
dequantizing to restore original input signal format before quantizing;
predicting a process that receives result of dequantizing process and generates an estimated value for next data;
generating variance after subtracting the estimated value from actual input signal from repetitive quantizing and dequantizing processes; and
resolution tuning to adapt to the reference code output from the quantizing process and generating a delta value, which has to be repetitively fed back to the quantizing and dequantizing processes before an optimal delta value is obtained;
wherein a decoding technique applies a subset of those processes used in the above mentioned encoding technique including the dequantizing, predicting and resolution tuning processes.

2. The method of adaptive pulse code modulation with frame width adjustment means as claimed in claim 1, wherein the frame width adjustment is based on the accumulated output value from several previous quantizing processes to generate a reference value for tuning the optimal delta value.

3. The method of adaptive pulse code modulation with frame width adjustment means as claimed in claim 2, wherein the output value used for frame width correction is derived from the summation of previous several outputs from the quantizing process multiplied by an appropriate coefficient.

4. An encoding apparatus of adaptive pulse code modulation with frame width adjustment means comprising:
a quantizer which receives an input signal and generates a code value representing output signal;
a dequantizer, of which the input is connected to the output of the quantizer;
a predictor, of which the input is connected to the output of the dequantizer, and the output is fed back to the input of the quantizer;
a code analyzer and corrector, of which the input is connected to receive an output code, and the output is connected to the adaptive delta tuner; and
an adaptive delta tuner, of which the input is connected to the output code from the code analyzer and corrector, and the output in the form of delta value is fed back to the quantizer and the dequantizer to change a next stage input to the quantizer and dequantizer;
wherein the decoding apparatus employs a subset of those components used in the above-mentioned encoding apparatus including the dequantizer, predictor and adaptive delta tuner.

5. The encoding apparatus of an adaptive pulse code modulation with frame width adjustment means as claimed in claim 4, wherein the code analyzer and corrector includes multiple delay elements used to accumulate output values from the quantizer.

6. The encoding apparatus of an adaptive pulse code modulation with frame width adjustment means as claimed in claim 5, wherein the code analyzer and corrector basing on the cumulative output value from delay elements is to generate a reference value for the adaptive delta tuner.

7. The encoding apparatus of an adaptive pulse code modulation with frame width adjustment means as claimed in claim 6, wherein the frame width modifier is to generate a reference value from the summation of absolute values from delay elements each multiplied by an appropriate coefficient.
